(19) United States
(12) Patent Application Publication
(10) Pub. No.: US 2011/0260412 A1
(43) Pub. Date: Oct. 27, 2011

(54) SEALING APPARATUS USING WIRE GASKET

(75) Inventor: Sung Sun YANG, Daegu-si (KR)

(73) Assignee: VACTRON CO., LTD., Daegu-si (KR)

(21) Appl. No.: 13/090,992

(22) Filed: Apr. 20, 2011

(30) Foreign Application Priority Data
Apr. 26, 2010 (KR) 10-2010-0038304

(51) Int. Cl. F16J 15/02

(52) U.S. Cl. 277/630

(57) ABSTRACT

Various exemplary embodiments of a sealing apparatus are disclosed. One exemplary embodiment may comprise, a first connection having a first flange at an end portion thereof, a second connection having a second flange joined to the first flange at an end portion thereof, a plurality of coupling members for coupling the first and second flanges to each other, a wire gasket disposed on a joining surface between the first flange and the second flange and pressed therebetween, and a plurality of gasket fixing member retractably supported in one of the first flange and the second flange and continuously wound by the wire gasket.

### CROSS-REFERENCE TO RELATED APPLICATION

This application claims priority under 35 U.S.C. §119(a) to Korean Patent Application No. 10-2010-0038304, filed on Apr. 26, 2010, the entire contents of which are hereby incorporated by reference.

### BACKGROUND

Various embodiments of the present disclosure relate to a sealing apparatus for joints used in e.g., transport pipes for vacuum, gas, and liquid of vehicles, vacuum apparatuses, and hydraulic apparatuses, and more particularly, to a sealing apparatus of a connection, which can facilitate a sealing process and maximize sealing efficiency by allowing a wire gasket to not deviate from a sealing part of the connection during the sealing process of a flange.

Sealing structures used for joining between a vacuum vessel used under ultra-high vacuum and a flange, or between vacuum vessels, are divided into con-flat (hereafter referred to as CF) sealing structures in which a metal plate of high plastic deformation is processed to be used as a gasket, helicoflex sealing structures in which a thin metal plate is covered over a ring formed as a spring, sealing structures using a metal wire gasket, and various improved CF sealing structures. According to the types of gaskets used in various sealing structures, a flange that is a sealing surface for sealing has to be processed to have unique shapes advantageous for coupling and airtightness of a gasket.

The CF sealing structure widely used in the field of ultra-high vacuum uses a gasket that is mainly formed of a copper plate. In order to facilitate a plastic deformation of a soft copper surface, a sharp knife edge has to be formed on a flange that is a sealing surface for sealing.

Since a gasket is resistant to an external force, it maintains its shape unless a special force is particularly applied to it. The gasket must not be deformed by the unique shape of the flange during sealing, or deviate from its installation location to cause a delay of working.

Since the shapes of a flange and a gasket are standardized in CF flanges, CF flanges are widely used as circular flanges having a diameter of about 16.5 inches or less. However, since it is difficult to manufacture the shape of flanges, the shapes of the flange and the gasket are not standardized for angular small flanges. Accordingly, the CF flange is limitedly used for angular small flanges, and the circular flanges are not standardized for large-sized apparatuses.

Since gaskets necessary for CF flanges have to be manufactured by punching a wide plate, the price of the gaskets is relatively high even though a non-standardized flange is used.

Accordingly, it is difficult to apply the CF sealing structure to a flange having a rectangular shape or an unusual shape, or a large-sized flange. Particularly, for a vacuum chamber or a large-sized flange having a diameter of about 16.5 inches or more, a helicoflex gasket or a metal wire gasket is used for a flange having an entirely flat shape without processing a special structure on the surface of the flange.

In the helicoflex gasket, since the joining surface of a flange is flat, and the shape of the gasket is not flexible, the helicoflex gasket can be applied to any type of circular or angular flange. Also, the helicoflex gasket can be used even when the joining surface of the flange is horizontal, vertical, or oblique with respect to the ground. However, since the helicoflex gasket is very expensive, maintenance costs are high if frequent disassembling and assembling are necessary.

In order to overcome the above-mentioned limitations, a metal wire is used as a gasket. However, when metal wire is used as a gasket, it may be difficult to maintain the regular shape of the gasket because flexible metal is usually used for the purpose of a large flange even when there is a difference according to the type and heat-treatment of metal constituting the gasket. Also, when the gasket is transferred or installed, it may be difficult to maintain its desired shape or to fix it at a desired position.

When metal wire is used as a gasket, there are two types of gasket shapes. One type is where the gasket is specially formed to have a looped shape, and the other is where the gasket uses a typical long metal wire.

In the former type, a gasket can be fixed on a flange and processed to fit the particular size of the gasket. This type is also standardized and used limitedly for a circular flange. However, although this type can be used even when the surface of the flange is horizontal or vertical, there is a technical difficulty in manufacturing the gasket.

In the latter type, since wires having an open curved-shape are overlapped as a gasket and the joining surface of a flange is flat, a flange can be easily manufactured and used without limits to its shape or size. Also, since there are no limits to the thickness and length of the wires necessary for the gasket, it can be very inexpensively and easily supplied compared to gaskets used in other types of sealing methods.

However, since a metal wire gasket used is thin, long, and flexible, it can be easily deformed by gravity and is not easy to fix on a flange, making the sealing process difficult. Accordingly, it has been limitedly used only for cases where the shape of a flange is rectangular, and the joining surface of the flange is horizontally placed with respect to the ground.

Accordingly, since there is no apparatus for fixing a wire gasket on a joining surface of a flange at a connection to which a metal wire gasket is coupled, it is difficult to perform a sealing process due to movement of the wire gasket during the sealing process when a metal wire gasket is used. Also, when the joining surface is not horizontal, it is impossible to fix the wire gasket, thereby making the sealing process difficult.

### SUMMARY

The present disclosure provides a sealing apparatus using a wire gasket, which can improve reliability and work efficiency of a sealing process by making it possible to provide convenience during the sealing process by fixing the wire gasket on a joining surface of a flange at a connection portion thereof, and to inhibit the movement of the wire gasket by fixing the wire gasket regardless of the direction of the joining surface of the connection portion.

Various exemplary aspects of the present disclosure may provide sealing apparatuses including: a first connection having a first flange at an end portion thereof; a second connection having a second flange joined to the first flange at an end portion thereof; a plurality of coupling members for coupling the first and second flanges to each other; a wire gasket disposed on a joining surface between the first flange and the second flange and pressed therebetween; and a plurality of gasket fixing members retractably supported in either the first flange or the second flange and continuously wound by the wire gasket.

In another exemplary aspect, the gasket fixing member may comprise: a plurality of pin insertion grooves disposed along a circumferential direction of either the first flange or the second flange; and a plurality of fixing pins partially inserted into the plurality of pin insertion grooves and continuously wound by the wire gasket at protruding portions of the plurality of fixing pins.

In still another exemplary aspect, the gasket fixing member may comprise: a plurality of pin insertion holes disposed along a circumferential direction of either the first flange or the second flange; and a plurality of fixing pins partially inserted into the plurality of pin insertion holes and continuously wound by the wire gasket at protruding portions of the plurality of fixing pins.

According to some exemplary aspects, the apparatus may further comprise a thread groove at a center of the fixing pin and a plurality of pin height control bolts coupled to the thread groove.

In one exemplary aspect, the apparatus may further comprise a spring for resiliently supporting the fixing pin in the pin insertion groove or the pin insertion hole into which the fixing pin is partially inserted.

In yet another exemplary aspect, the gasket fixing member may be coupled to an outer circumferential surface of either the first flange or the second flange through an interference fit, and may include a plurality of fixing protrusions around which the wire gasket is continuously wound at a protruding side of the flange.

In yet still another exemplary aspect, the fixing pin may be partially coupled to the pin insertion groove by frictional coupling of an outer circumferential portion thereof.

According to another exemplary aspect, sealing apparatuses comprise: a first connection having a first flange at an end portion thereof; a second connection having a second flange joined to the first flange at an end portion thereof; a plurality of coupling members for coupling the first and second flanges to each other; and a wire gasket continuously wound around the plurality of coupling members to be pressed and fixed on a joining surface between the first flange and the second flange.

In some exemplary aspects, the joining surface of one of the first flange and the second flange may include a stepped portion on a path that the wire gasket passes.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention.

FIG. 1 is a perspective view illustrating a sealing apparatus according to one embodiment of the present invention.

FIGS. 2A through 2I are cross-sectional views illustrating a pin used in the sealing apparatus of FIG. 1.

FIG. 3 is a perspective view illustrating a sealing apparatus according to another embodiment of the present invention.

FIGS. 4 and 5 are perspective views illustrating a sealing process using the sealing apparatus of FIG. 3.

FIG. 6 is a perspective view illustrating a sealing state completed using the sealing apparatus of FIG. 3.

FIG. 7 is a partial cross-sectional view illustrating a sealing state completed using the sealing apparatus of FIG. 3.

FIG. 8 is a perspective view illustrating a sealing apparatus according to another embodiment of the present invention.

FIG. 9 is a perspective view illustrating a fixing ring used in the sealing apparatus of FIG. 8.

FIG. 10 is a schematic view illustrating a joining structure between vacuum vessels to which a sealing apparatus of the present invention is applied.

### DETAILED DESCRIPTION OF THE EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, exemplary embodiments of the present invention will be described in detail with reference to the accompanying drawings.

FIG. 10 is a schematic view illustrating a joining structure between vacuum vessels to which a sealing apparatus of the present invention is applied.

Referring to FIG. 10, the sealing apparatus is applied to a joint 30 between a main vacuum vessel 10 and a sub vacuum vessel 20, and a joint 30 for sealing a port 40 that is opened on one side of the main vacuum vessel 10. Each of the joints 30 has a joining structure in which a first flange 111 and a second flange 111a are coupled to each other.

Hereinafter, a sealing apparatus that is applied to a flange-type joint of a vacuum vessel according to an embodiment of the present invention will be described in detail.

Also, the sealing apparatus according to the present invention is used in transport pipes for vacuum, gas, and liquid of vehicles and hydraulic apparatuses

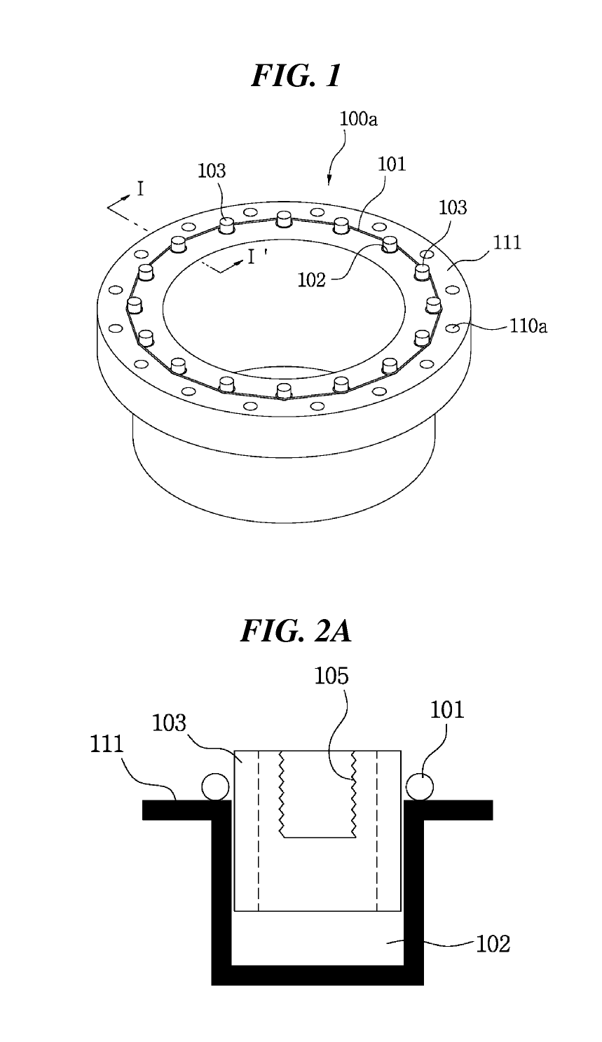

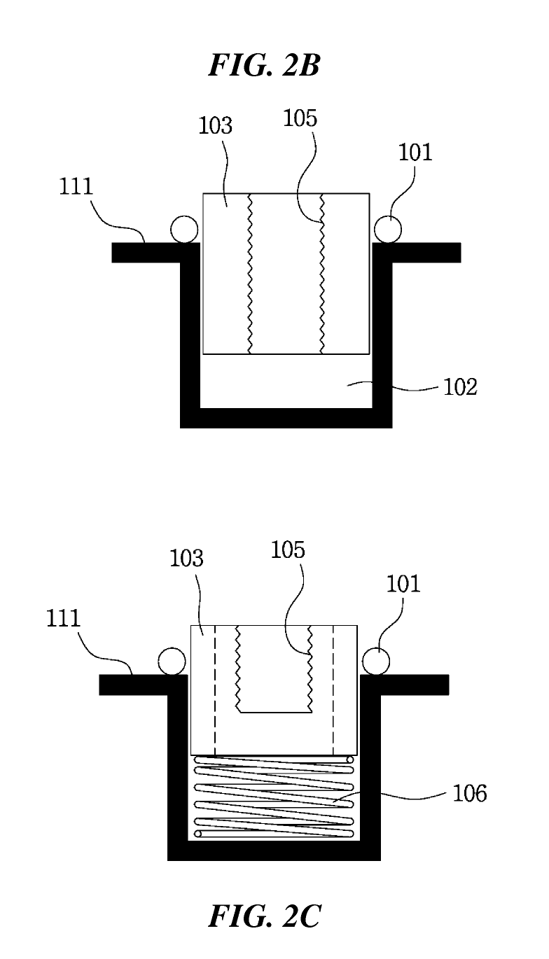

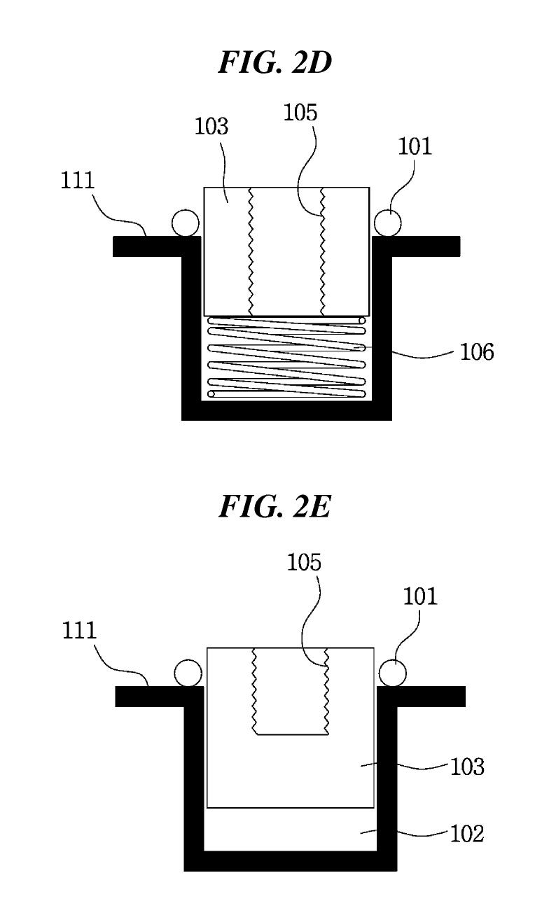

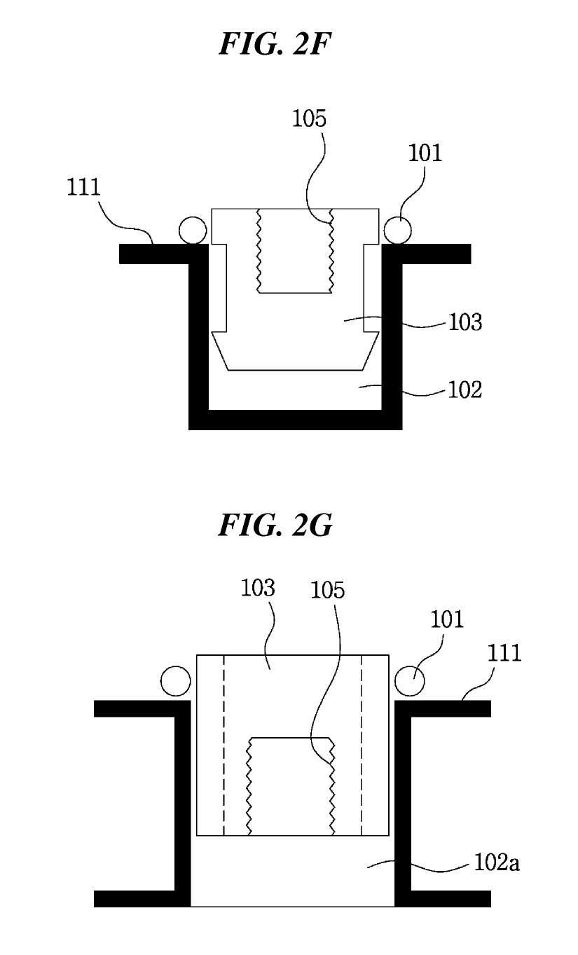

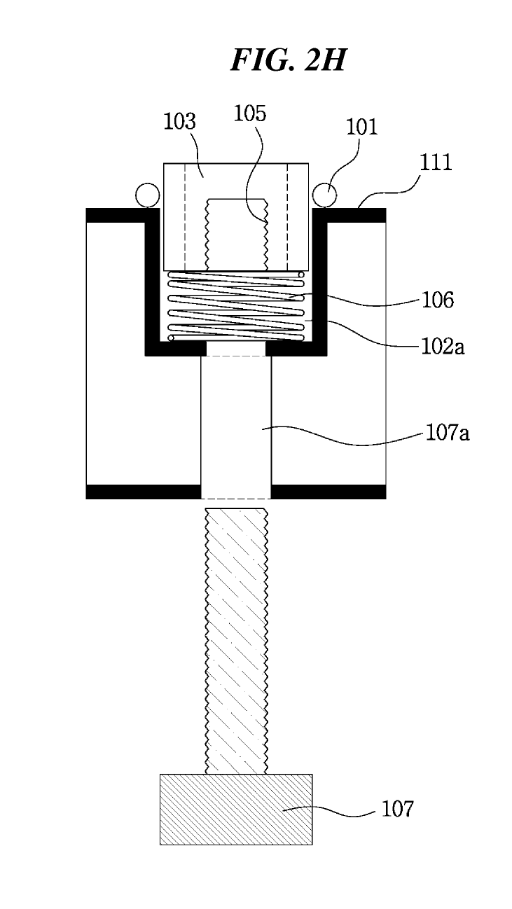

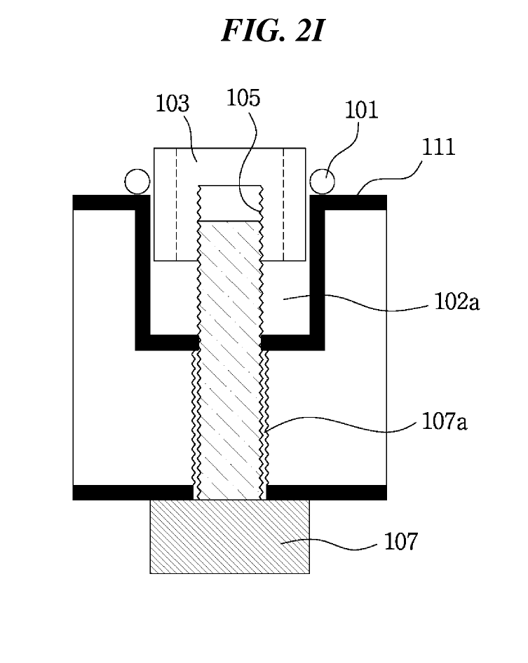

FIG. 1 is a perspective view illustrating a sealing apparatus according to one embodiment of the present invention. FIGS. 2A through 2I are cross-sectional views illustrating a pin used in the sealing apparatus of FIG. 1.

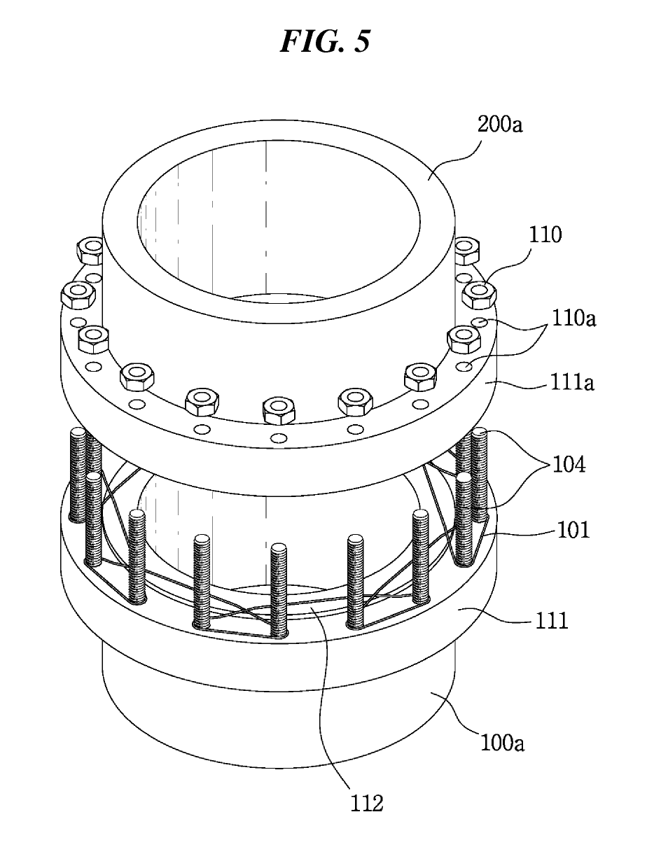

Referring to FIGS. 1 and 10, a flange-type joint of a vacuum vessel may include first and second flanges 111 and 111a having a circular shape on the end portion of first and second connection 100a and 200a extending from vacuum vessels 10 and 20, respectively. A plurality of bolt insertion holes 110a are arranged along a circumferential direction. A fixing bolt 104 (see FIG. 5) is inserted into the bolt insertion hole 110a to mutually fix the first and second flanges 111 and 111a forming the joint 30 between the vacuum vessels 10 and 20. A plurality of pin insertion grooves 102 are arranged along a circumferential direction at an equal interval. A plurality of fixing pins 103 are inserted into the plurality of pin insertion grooves 102, respectively.

The plurality of fixing pins 103 protrude to the outside to wind and fix a wire gasket 101. When the first flange 111 is joined to the second flange 111a, the plurality of fixing pins are inserted into the pin insertion grooves 102.

In the sealing apparatus according to one embodiment of the present invention, the pin insertion groove 102 is formed on the surface of the first flange 111 that is formed on the first connection 100a formed of metal such as stainless steel or aluminum. The fixing pin 103 formed of plastic material such as Teflon or soft metal such as aluminum is partially inserted into the pin insertion groove 102. The wire gasket 101 is wound and fixed on the plurality of fixing pins 103 protruding to the outside and the second flange 111a of the second connection 200a is joined to complete the sealing.

The fixing pin 103 inserted into the pin insertion groove 102 has to protrude to the outside of the pin insertion groove 102 such that a portion of the fixing pin 103 can secure the wire gasket 101. The protruding length of the fixing pin 103 protruding from the first and second flanges has to be greater than the diameter of the wire gasket 101 used in vacuum airtightness.

Thus, the wire gasket 101 can be fixed on the fixing pin 103 during the sealing process of the joint 30 to prevent deviation from the sealing spot of the joint 30, thereby increasing work efficiency during the sealing process.

FIGS. 2A through 2I are cross-sectional views taken along line I-I′ to describe a support structure of the pin used in the sealing apparatus of FIG. 1.

FIGS. 2A through 2I each show a processed state of the pin insertion hole 102 receiving the fixing pin 103 in the first flange 111 to fix the wire gasket 101.

A lower space is formed in the pin insertion groove 102 such that the fixing pin 103 is partially inserted and then further inserted upon a joining between flanges. According to the coupling method of a pin height control bolt 107, the fixing pin 103 has a thread groove 105 therein or has a thread on inner circumferential surface through the whole of the fixing pin 103 (see FIGS. 2A and 2B).

Referring to FIGS. 2A, 2C, and 2G through 21, the fixing pin 103 is coupled to the pin insertion groove 102 through a screw coupling method to facilitate retraction by a frictional coupling during the joining of the flanges.

Also, a spring 106 is disposed in the residual space of the pin insertion groove 102 that receive a portion of the fixing pin 103. Accordingly, during the joining of the flanges, the fixing pin 103 is further inserted into the pin insertion groove 102 by a resilient force.

Furthermore, the fixing pin 103, as shown in FIG. 2F, includes a circular protrusion protruding at a lower portion thereof to facilitate retraction by frictional coupling during the joining of the flanges.

FIGS. 2G through 2I show pin insertion holes 102a formed in the first flange 111. In the drawings, the fixing pins 103 are partially inserted into the pin insertion holes 102a.

A support structure of the fixing pin 103 shown in FIG. 2G is applicable to a case where the thickness of the first flange 111 is small. Here, the fixing pin 103 is inserted into the pin insertion hole 102a.

Referring to FIG. 2H, a spring 106 is disposed under the fixing pin 103 in the pin insertion hole 102a, and resiliently supports the fixing pin 103. At the lower portion of the pin insertion hole 102a, a pin height control bolt 107 is coupled to a thread groove 105 of the fixing pin 103 through a threw coupling method to adjust the protruding height of the fixing pin 103.

In a support structure of the fixing pin 103 shown in FIG. 21, the pin height control bolt 107 is partially inserted into the thread groove 105 of the fixing pin 103 while penetrating a bolt coupling hole 107a through a screw coupling method, thereby adjusting the protruding height of the fixing pin 103 and receiving the fixing pin 103 in an internal space in which the thread groove 105 is formed and an internal space of the pin insertion hole 102a.

The shapes of the fixing pins described above are not limited to those described in the embodiments of the present invention. For example, as long as the fixing pins are outwardly protruded from the pin insertion groove 102 or the pin insertion hole 102a, and a space for receiving the fixing pins is formed in the pin insertion groove 102 or the pin insertion hole 102a, any structure of fixing pins is applicable without being limited to those of the embodiments described above.

The dotted lines of the fixing pins 103 of FIGS. 2A, 2C, 2G, 2H, and 21 represent holes that are formed in a longitudinal direction at both sides thereof to reduce an air pressure during the insertion of the fixing pins 103 into the pin insertion groove 102 or the pin insertion hole 102a.

Also, the wire gasket 101 may be formed of a material, e.g., metal that may be deformed by a pressure applied to the first and second flanges 111 and 111a of the first and second connection 100a and 200a and may maintain their airtightness in the sealing state in which joints 30 are mutually coupled to each other.

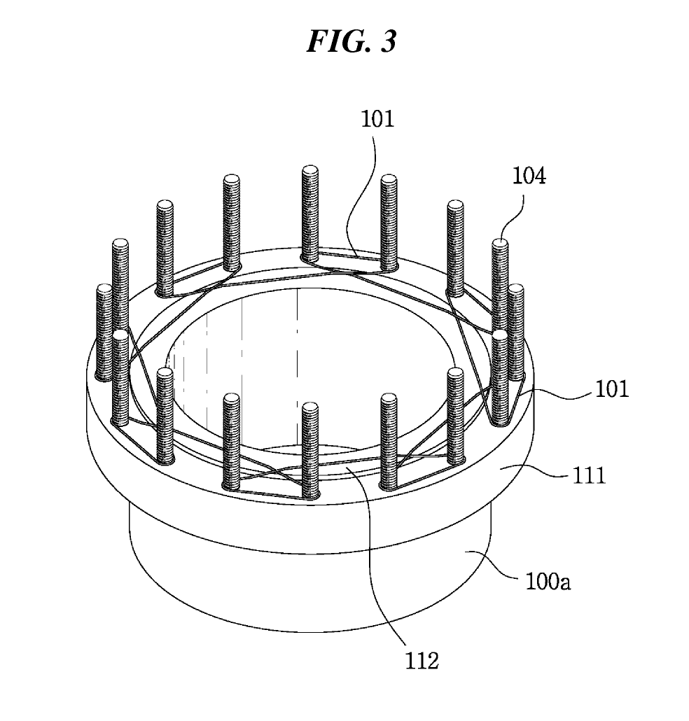

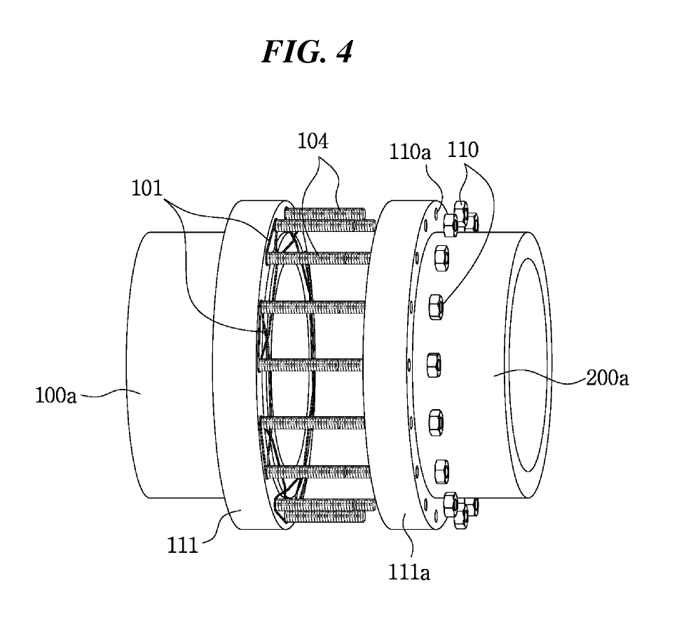

FIG. 3 is a perspective view illustrating a sealing apparatus according to a second embodiment of the present invention. FIGS. 4 and 5 are perspective views illustrating a sealing process using the sealing apparatus of FIG. 3.

Referring to FIGS. 3 through 5, first and second connections 100a and 200a protruding from vacuum vessels include first and second flanges 111 and 111a having a circular shape at the end portion thereof, respectively.

When a plurality of fixing bolts 104 are coupled to the first flange 111 of the first connection 100a, a plurality of bolt insertion holes 110a are formed in the second flange 111a of the second connection 200a corresponding to the plurality of fixing bolts 104. The plurality of bolt insertion holes 110a are arranged along a circumferential direction in a circular pattern.

The sealing apparatus of the second embodiment achieves sealing between the first and second flanges 111 and 111a using the fixing bolt 104.

In the sealing between the first and second flanges 111 and 111a, a wire gasket 101 is wound around two or three of fixing bolts 104 that are disposed along the first flange 111.

Thereafter, when the winding of the wire gasket 101 is completed, the fixing bolt 104 is inserted into the bolt insertion hole 110a of the second flange 111a to fasten a nut 110, thereby achieving a coupling between the first and second flanges 111 and 111a. Thus, when the first and second flanges 111 and 111a are joined to each other in a state where the wire gasket 101 is wound around the first flange 111, the sealing is completed.

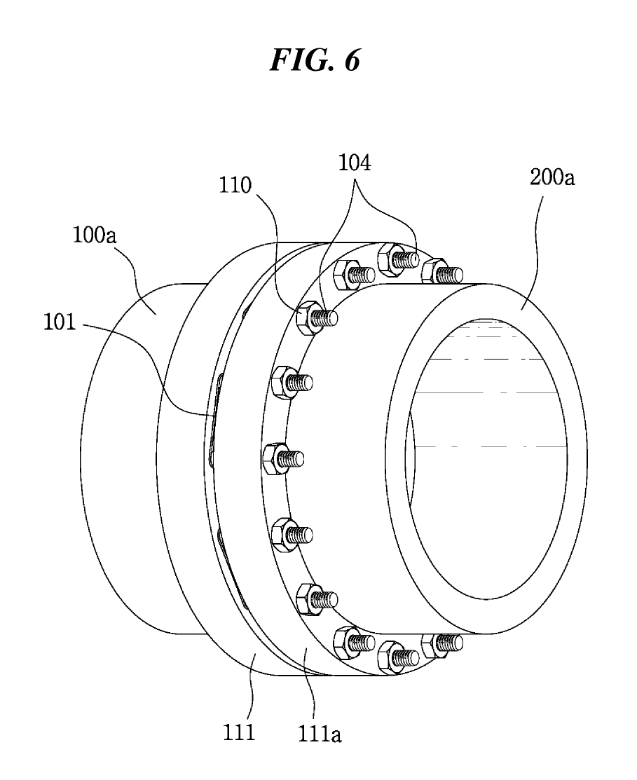

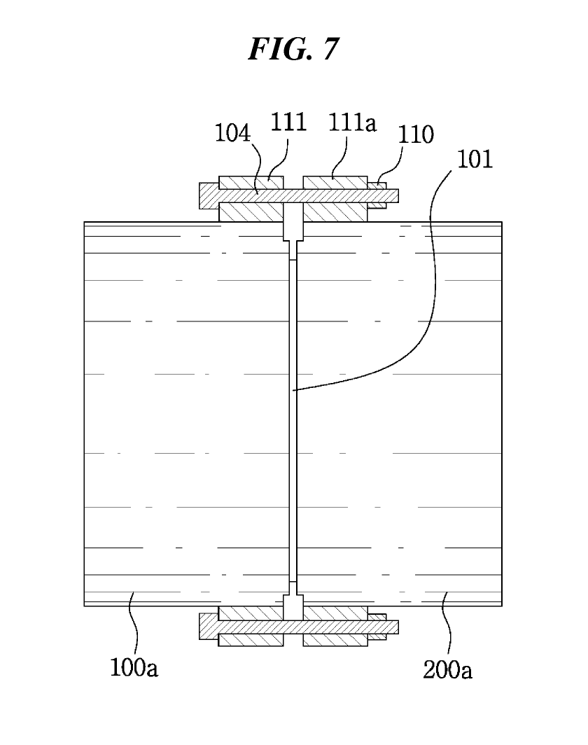

The sealing state as described above is shown in FIGS. 6 and 7.

FIG. 6 is a perspective view illustrating a sealing state completed using the sealing apparatus according to another embodiment. FIG. 7 is a partial cross-sectional view illustrating a sealing state completed using the sealing apparatus according to another embodiment.

Referring to FIGS. 6 and 7, in the first and second flanges 111 and 111a to which the first connection 100a and the second connection 200a are joined, respectively, since the fixing bolt 104 is inserted into the bolt insertion hole 110a in a state where the wire gasket 101 is wound around the fixing bolt 104, the fixing bolt 104 is coupled by the nut 110 to achieve both coupling and sealing between the first and second flanges 111 and 111a at the same time.

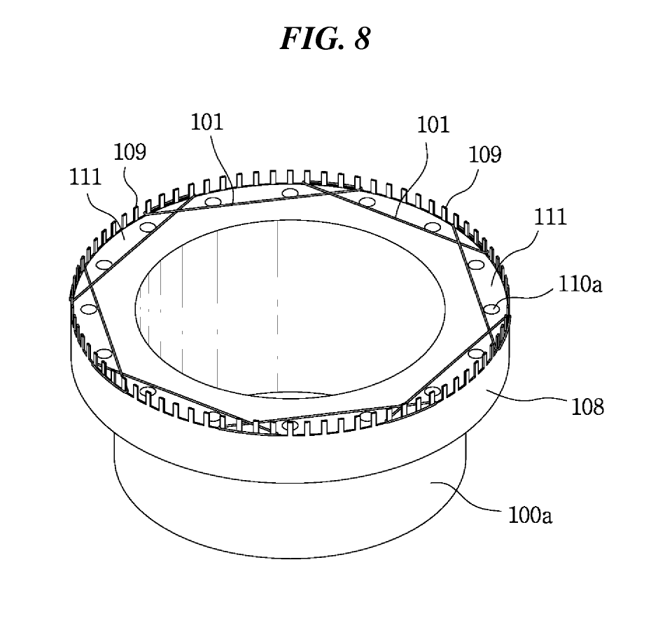

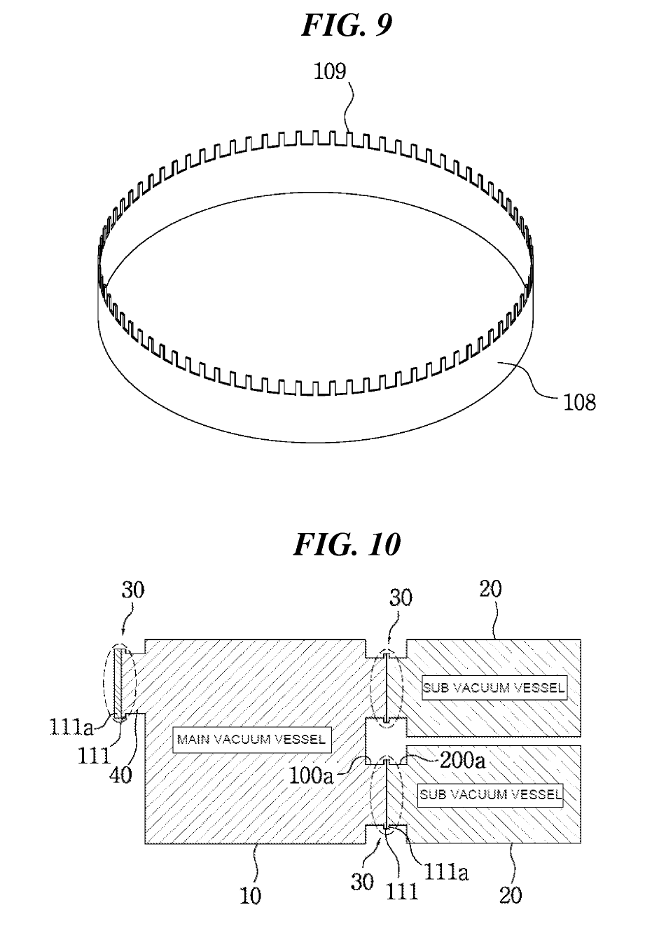

FIG. 8 is a perspective view illustrating a sealing apparatus according to another embodiment of the present invention. FIG. 9 is a perspective view illustrating a fixing ring used in the sealing apparatus of FIG. 8.

Referring to FIGS. 8 and 9, the sealing apparatus according to the third embodiment fixes a wire gasket 101 using a fixing ring 108 that is coupled to the outer circumferential surface of a first flange 111 coupled to a first connection 100a.

As shown in FIG. 9, the fixing ring 108 has a plurality of fixing protrusions 109 protruding from the first flange 111 along the upper edge thereof. The fixing protrusion 109 allows the wire gasket 101 to be wound therearound. The fixing protrusions are provided enough to wind the wire gasket 101 in its number or height.

Here, the fixing ring 108 may be formed of flexible and cheap material such as Teflon or plastic to be applied the first flange 111 or various shapes of flanges.

In the sealing apparatus according to the third embodiment, the fixing ring 108 is coupled to the outer circumferential surface of the first flange 111 of the first connection 100a through an interference fit, and then the wire gasket 101 is wound around the fixing protrusions 109. Thereafter, the second flange 111a of the second connection 200a is coupled, and then a fixing bolt 104 is inserted into a bolt insertion hole 110a to be coupled to a nut 110 for sealing.

The fixing pins, the fixing bolts, and the fixing ring are fixing means for winding and fixing the wire gasket on the joining surface of the flange.

The joining surfaces of the first and second flanges 111 and 111a that face each other may be flat to achieve a sealing structure. However, although the joining surfaces of the flanges 111 and 111a are uneven, when a stepped portion 112 protruding compared to an outer circumferential portion is formed on a path that the wire gasket 101 passes, for example, on the joining surface of any of flanges 111 and 111a as shown in FIG. 7, sealing may be achieved due to the wire gasket 101 disposed on the stepped portion 112.

As described above, it is possible to provide convenience during a sealing process by enabling a wire gasket to be fixed on a joining surface of a flange of a connection that connects vacuum vessels to each other. The reliability and work efficiency of the sealing process can be improved regardless of the direction of the joining surface of the flange since the wire gasket can be fixed to inhibit the movement of the wire gasket,

The sealing apparatus according to an embodiment of the present invention can be applied to mass transit of liquids and gases through pipe lines, as well as vacuum apparatuses, hydraulic apparatuses, and industrial apparatuses. Also, since a wire gasket formed of a metal material is used, sealing structure resistant to heat can be achieved. Accordingly, the sealing apparatus can be applied to high-temperature apparatuses such as electric furnaces that require vacuum like silicon ingot manufacturing apparatuses without an additional cooling apparatus.

According to an embodiment of the present invention, since sealing is performed by fixing a wire gasket on a joining surface of a flange at a connection portion thereof, the sealing process can be easily performed and the airtightness of the joining portion can be improved.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A sealing apparatus comprising:
a first connection having a first flange at an end portion thereof;
a second connection having a second flange joined to the first flange at an end portion thereof;
a plurality of coupling members for coupling the first and second flanges to each other;
a wire gasket disposed on a joining surface between the first flange and the second flange and pressed therebetween; and
a plurality of gasket fixing member retractably supported in one of the first flange and the second flange and continuously wound by the wire gasket.

2. The sealing apparatus of claim 1, wherein the gasket fixing member comprises:
a plurality of pin insertion grooves disposed along a circumferential direction of either the first flange or the second flange; and
a plurality of fixing pins partially inserted into the plurality of pin insertion grooves and continuously wound by the wire gasket at protruding portions of the plurality of fixing pins.

3. The sealing apparatus of claim 1, wherein the gasket fixing member comprises:
a plurality of pin insertion holes disposed along a circumferential direction of either the first flange or the second flange; and
a plurality of fixing pins partially inserted into the plurality of pin insertion holes and continuously wound by the wire gasket at protruding portions of the plurality of fixing pins.

4. The sealing apparatus of claim 2, further comprising a thread groove at a center of the fixing pin, and a plurality of pin height control bolts coupled to the thread groove.

5. The sealing apparatus of claim 3, further comprising a thread groove at a center of the fixing pin, and a plurality of pin height control bolts coupled to the thread groove.

6. The sealing apparatus of claim 2, further comprising a spring for resiliently supporting the fixing pin in the pin insertion groove or the pin insertion hole into which the fixing pin is partially inserted.

7. The sealing apparatus of claim 3, further comprising a spring for resiliently supporting the fixing pin in the pin insertion groove or the pin insertion hole into which the fixing pin is partially inserted.

8. The sealing apparatus of claim 1, wherein the gasket fixing member is coupled to an outer circumferential surface of either the first flange or the second flange through an interference fit, and comprises a plurality of fixing protrusions around which the wire gasket is continuously wound at a protruding side of the flange.

9. The sealing apparatus of claim 2, wherein the fixing pin is partially coupled to the pin insertion groove by frictional coupling of an outer circumferential portion thereof.

10. A sealing apparatus comprising:
a first connection having a first flange at an end portion thereof;
a second connection having a second flange joined to the first flange at an end portion thereof;
a plurality of coupling members for coupling the first and second flanges to each other; and
a wire gasket continuously wound around the plurality of coupling members to be pressed and fixed on a joining surface between the first flange and the second flange.

11. The sealing apparatus of claim 10, wherein the joining surface of one of the first flange and the second flange comprises a stepped portion on a path that the wire gasket passes.
